(19) United States
(12) Patent Application Publication
(10) Pub. No.: US 2012/0197588 A1
(43) Pub. Date: Aug. 2, 2012

(54) APPARATUS AND METHOD FOR INSPECTING ROAD SURFACES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/083,656

(22) Filed: Apr. 11, 2011

(30) Foreign Application Priority Data
Jan. 27, 2011 (TW) 100102985

(51) Int. Cl. G06F 15/00

(52) U.S. Cl. 702/141

(57) ABSTRACT

An apparatus for inspecting road surfaces includes a global positioning system (GPS) unit, an acceleration sensor, a comparing module, and a storing module. The GPS unit is mounted on a car to detect a position of the car. The acceleration sensor is mounted on the car to sense vertical movement of the car. The vertical movement of the car is recorded as a coordinate along a Z-axis of the car. The comparing module compares the coordinate along the Z-axis of the car with a reference coordinate. The storing module stores the coordinate along the Z-axis and the position corresponding to the coordinate when the coordinate along the Z-axis is greater than the reference coordinate.

### BACKGROUND

1. Technical Field

The present disclosure relates to a system and a method for inspecting road surfaces for damage.

2. Description of Related Art

In order to make plans for road maintenance, road inspections are routinely performed. These inspections are performed visually requiring that an inspector to physically traverse sections of road to be inspected, which is time-consuming, and the results are subject to human error.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an apparatus for inspecting road surfaces, the apparatus includes a first storage unit.

FIG. 2 is a schematic diagram of the apparatus of FIG. 1.

FIG. 3 is a schematic diagram of the apparatus of FIG. 1 in a state of use.

FIG. 4 is another schematic diagram of the apparatus of FIG. 1 in a state of use.

FIG. 5 is a flowchart of an exemplary embodiment of a method for inspecting road surfaces.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

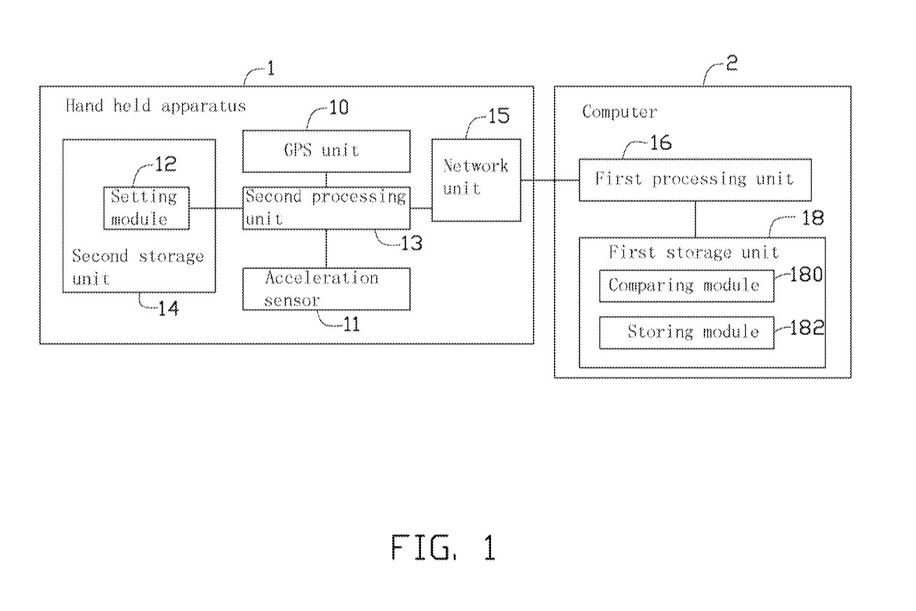

Referring to FIG. 1, an exemplary embodiment of an apparatus for inspecting road surfaces includes a global positioning system (GPS) unit 10, an acceleration sensor 11, a first processing unit 16, a first storage unit 18, a network unit 15, a second processing unit 13, and a second storage unit 14. In the embodiment, the GPS unit 10, the acceleration sensor 11, the second processing unit 13, the second storage unit 14, and the network unit 15 are set in a hand held apparatus, such as a mobile phone 1. The first processing unit 16 and the first storage unit 18 are set in a computer 2. The mobile phone 1 communicates with the computer 2 with the network unit 15. The GPS unit 10, the acceleration sensor 11, the second storage unit 14, and the network unit 15 are all connected to the second processing unit 13. The first processing unit 16 is connected to the first storage unit 18.

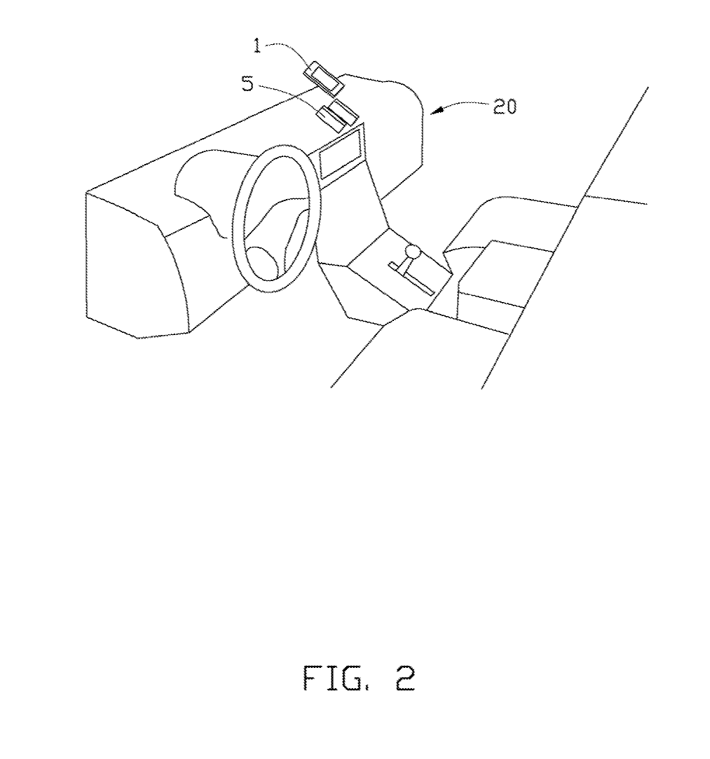

Referring to FIG. 2, the mobile phone 1 is mounted on a bracket 5 attached to a car 20. The principal of the present disclosure is that a road in good repair should provide a smooth ride. If there are potholes, bumps or the like in the road, then a car traveling over these flaws should experience a bumpy ride that can be detected by acceleration sensors. The GPS unit 10 continuously tracks the position of the car 20, so that the exact location of any detected flaws in the road can be determined and recorded. The acceleration sensor 11 continuously detects vertical movement of the car 20, with special notice taken of sudden accelerations perpendicular to the road surface, which may indicate the presence of a flaw in the road. The GPS unit 10 and the acceleration sensor 11 respectively output the position and the vertical movement of the car 20 to the second processing unit 13. Each position corresponds to a vertical movement. In the embodiment, the position of the car 20 can be recorded as longitude and latitude. The vertical movement of the car 20 can be recorded as coordinates about an X-axis and Y-axis, corresponding to latitude and longitude and a Z-axis corresponding to sudden acceleration along the vertical direction. Sudden acceleration along the vertical direction is used to detect a flaw in the road.

The second storage unit 14 includes a setting module 12 (FIG. 1) which may include one or more computerized instructions to be executed by the second processing unit 13. The setting module 12 is used to set a work mode of the apparatus. When the apparatus is in an automatic mode, the acceleration unit 11 detects the vertical movement of the car 20. When the apparatus is in a manual mode, the acceleration unit 11 does not operate.

The first storage unit 18 includes a comparing module 180 which may include one or more computerized instructions to be executed by the first processing unit 16, and a storing module 182. The position and the vertical movement of the car 20 are transmitted to the first processing unit 16 from the second processing unit 13 through the network unit 15. The comparing module 180 compares a coordinate of the Z-axis of the car 20 with a reference coordinate. The reference coordinate is defined as an allowable peak value of the flaw in the road. When a coordinate of the Z-axis of the car is greater than the reference coordinate, it denotes that there may be flaws in the road at this position. At this time, the first processing unit 16 stores a position of the car 20 corresponding to the coordinates in the storing module 182. Moreover, the GPS unit 10 further detects a direction of horizontal movement of the car 20 to make sure which side of the road needs repair, such as northbound lane.

In addition, an operator can prioritize which road needs to be repaired according to the coordinate of the Z-axis of the car 20. In other words, the greater the acceleration along the Z-axis of the car 20, the bigger the flaw and so a higher priority is attributed to this section of the road. Moreover, if there are many flaws detected in a particular section of road, the first processing unit 16 further marks the section of road to alert the operator that the section of road may need to be rebuilt.

If a road is naturally bumpy, the operator can set the apparatus in manual mode by operating the setting module 12, and take the mobile phone 1 from the car 20. At this time, the acceleration unit 11 does not operate. If the operator considers any part of road need repairing, the operator can record information such as a depth of the pothole in the storing module 182. At the same time, the GPS unit 10 records a position of the mobile phone 1.

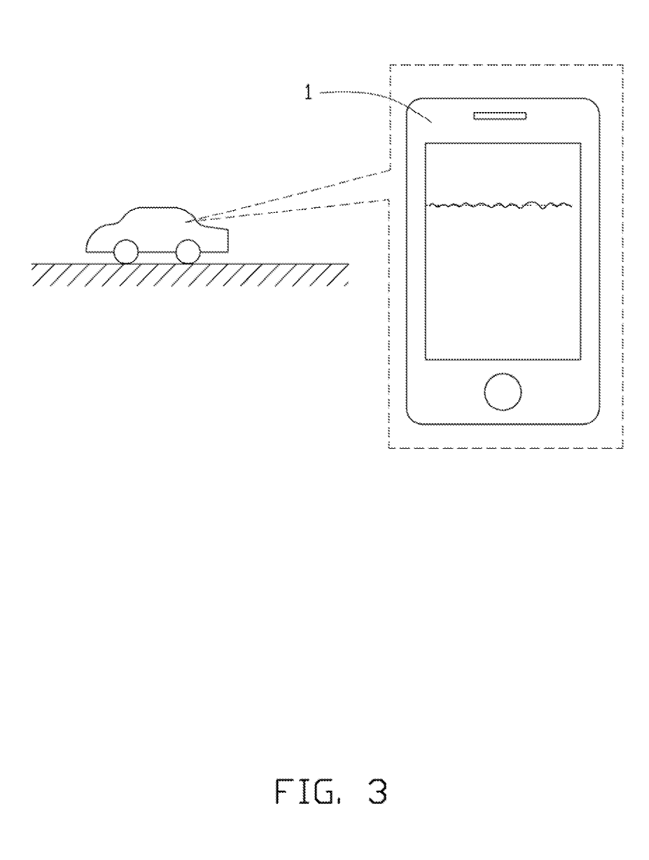

Referring to FIG. 3, when the car 20 travels a first section of road, the setting module 12 is operated to set the apparatus in the automatic mode. At this time, the GPS unit 10 detects the position of the car 20, and the acceleration unit 11 detects the vertical movement of the car 20 correspondingly. The positions and the vertical movement of the car 20 that the first processing unit 16 receives are shown on the display of the mobile phone 1 in FIG. 3. The comparing module 180 compares the coordinate of the Z-axis at each position with the reference coordinate to determine whether each coordinate of the Z-axis is less than or equal to the reference coordinate. In this case, the readings, shown as the wavy line on the display of the mobile phone of FIG. 3, indicate that deviations from the reference coordinate, shown as a broken straight line superimposed on the wavy line of FIG. 3, are less than a maximum deviation, so the first section of the road meets all requirements, and does not need to be repaired.

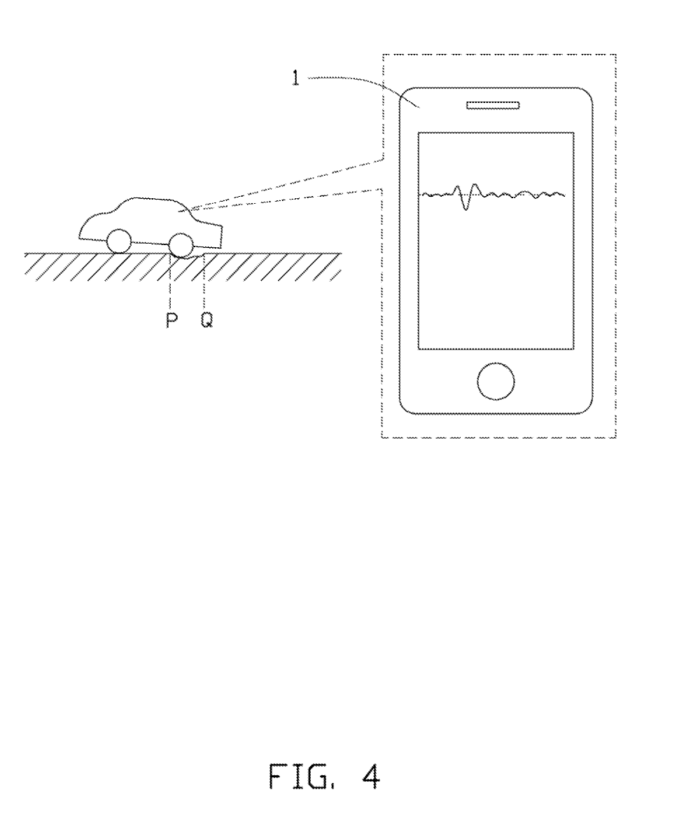

Referring to FIG. 4, when the car 20 travels a second section of road, the GPS unit 10 detects the position of the car 20, and the acceleration unit 11 detects the vertical movement of the car 20 correspondingly. The positions and the vertical movement of the car 20 that the first processing unit 16 receives are shown on the display of the mobile phone 1 in FIG. 4. The comparing module 180 compares the coordinate of the Z-axis at each position with the reference coordinate to determine that the coordinates of the Z-axis when the car 20 is between a point P and a point Q on the second section of road is greater than the reference coordinate. The readings, shown as the wavy line on the display of the mobile phone of FIG. 4, indicate that deviations from the reference coordinate, shown as a broken straight line, between the point P and the point Q are greater than the maximum deviation, so a section of the road between the point P and the point Q on the second section of road needs to be repaired.

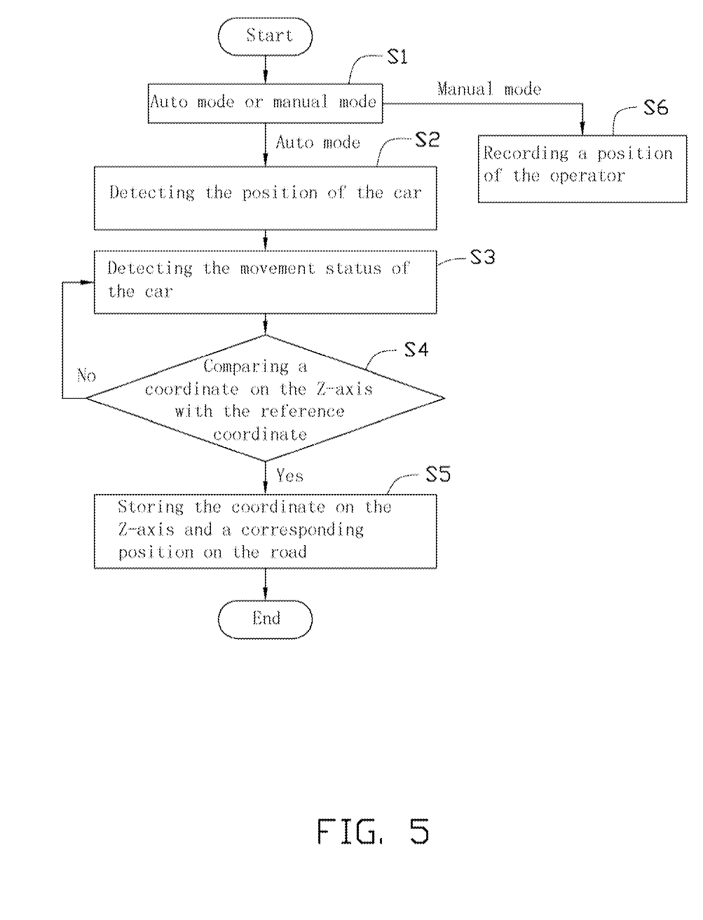

Referring to FIG. 5, an exemplary embodiment of a method for inspecting road surfaces includes the following steps.

In step S1, the setting module 12 sets a mode of the apparatus, such as an automatic mode or a manual mode.

In step S2, when the setting module 12 sets the apparatus in an automatic mode, the GPS unit 10 detects the position of the car 20, and transmits the position of the car 20 to the first processing unit 16 through the second processing unit 13 and the network unit 15.

In step S3, the acceleration unit 11 detects the vertical movement of the car 20 and transmits the vertical movement of the car 20 to the first processing unit 16 through the second processing unit 13 and the network unit 15. In this embodiment, the vertical movement of the car 20 is recorded as a coordinate of the Z-axis.

In step S4, the comparing module 180 compares the coordinate of the Z-axis with the reference coordinate. If the coordinate of the Z-axis is less than or equal to the reference coordinate, then the road at the corresponding position meets requirements, namely the road at this position does not need to be repaired, and the process returns to step S3.

In step S5, if the coordinate of the Z-axis is greater than the reference coordinate, the first processing unit 16 stores the coordinate of the Z-axis and a corresponding position on the road in the storing module 182. In this state, the surface at this position on the road does not meet requirements, and needs to be repaired.

In step S6, when the setting module 12 sets the apparatus in a manual mode, the acceleration unit 11 does not operate, and the GPS unit 10 records a position of the mobile phone 1 as the operator inspects the road surface. If the operator considers a section of the road needs repair then the operator can record details, such as a depth of a pothole, in the storing module 182.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An apparatus for inspecting road surfaces, the apparatus comprising:
a global positioning system (GPS) unit mounted to a car to detect a position of the car;
an acceleration sensor mounted to the car to sense vertical movement of the car, wherein the vertical movement of the car is recorded as a coordinate along a Z-axis of the car;
a first processing unit;
a second processing unit connected to the GPS unit and the acceleration unit to receive the position and the vertical movement of the car, wherein the second processing unit transmits the position and the vertical movement of the car to the first processing unit;
a first storage unit connected to the first processing unit and storing a plurality of programs to be executed by the first processing unit, wherein the first storage unit comprises:
a comparing module to compare the coordinate along the Z-axis of the car with a reference coordinate; and
a storing module to store the coordinate along the Z-axis and the position corresponding to the coordinate when the coordinate along the Z-axis is greater than the reference coordinate.

2. The apparatus of claim 1, wherein the GPS unit and the acceleration sensor are mounted in a hand held apparatus, the hand held apparatus further comprises a network unit; the first processing unit and the first storage unit are mounted in a computer, the first processing unit communicates with the second processing unit through the network unit.

3. The apparatus of claim 2, further comprising:
a second storage unit connected to the second processing unit and storing a plurality of programs to be executed by the second processing unit, wherein the second storage unit comprises:
a setting module to set a work mode of the apparatus, wherein when the apparatus is in an automatic mode, the acceleration unit works, and when the apparatus is in a manual mode, the acceleration unit does not operate, and the GPS unit further detects a position of the hand held apparatus.

4. A method for inspecting road surfaces, the method comprising:
detecting a position of a car by a global position system (GPS) unit;
sensing vertical movement of the car by an acceleration sensor, wherein the vertical movement of the car is recorded as a coordinate along a Z-axis of the car;
determining whether the coordinate along the Z-axis of the car is greater than a reference coordinate; and
recording the coordinate along the Z-axis of the car and the corresponding position when the coordinate along the Z-axis of the car is greater than the reference coordinate.

5. The method of claim 5, further comprising:
determining a number of recorded positions between a defined length of the road; and
marking a corresponding section of road to be rebuilt when the number of recorded positions greater than a defined number.
